(19) United States
(12) Patent Application Publication
(10) Pub. No.: US 2026/0118873 A1
(43) Pub. Date: Apr. 30, 2026

(54) BIO-NEURAL NAVIGATION AND INTELLIGENT INTRUSION DETECTION FOR UAV SYSTEMS

(71) Applicant: Shubham Chandra, Katy, TX (US)

(72) Inventor: Shubham Chandra, Katy, TX (US)

(21) Appl. No.: 18/906,169

(22) Filed: Oct. 4, 2024

(51) Int. Cl. G05D 1/243; B64U 10/80; G05B 13/02; G05D 1/245; G05D 1/633; G05D 1/644; G05D 101/15; G05D 101/20; G05D 109/20; G06F 18/25

(52) U.S. Cl. CPC G05D 1/243; B64U 10/80; G05B 13/027; G05D 1/245; G05D 1/633; G05D 1/644; G06F 18/251; B64U 2201/10; G05D 2101/15; G05D 2101/20; G05D 2109/20

(57) ABSTRACT

This invention presents a bio-neural navigation and intelligent intrusion detection system for UAVs, inspired by the head direction (HD) system in fruit flies. The navigation system uses a neural network-based architecture to process visual inputs and maintain orientation with a ring attractor network, enabling stable, autonomous flight in complex, GPS-denied environments. The multi-modal intrusion detection module integrates visual, radar, and acoustic sensor data to detect, classify, and respond to intrusions or obstacles in real-time. Combining supervised and unsupervised machine learning, it performs threat assessments and initiates adaptive responses like evasive maneuvers and dynamic re-routing. The integration of bio-neural navigation and intrusion detection ensures secure, autonomous UAV operations with enhanced situational awareness and threat management. This system is ideal for autonomous surveillance, urban air traffic management, and military reconnaissance, where adaptive navigation is critical.

### BACKGROUND

### Technical Field

The present invention relates to the field of intelligent Unmanned Aerial Vehicle (UAV) systems and bio-inspired robotics. More specifically, it introduces a novel framework that combines a bio-inspired navigation system with an intelligent intrusion detection mechanism to enable secure and autonomous UAV navigation. This invention was developed without the support of any federally or government-sponsored research or development funding.

### Technical Background of the Invention

Unmanned Aerial Vehicles (UAVs), often referred to as drones, have become indispensable tools for a wide range of applications, including surveillance, reconnaissance, and autonomous exploration. However, these systems face considerable challenges when operating in complex environments, GPS-denied areas, or when encountering potential airspace intrusions from other UAVs. Traditional navigation systems heavily rely on GPS signals and predefined waypoints, which can be unreliable or even fail completely in dense urban settings or areas with obstructed signals. Moreover, conventional intrusion detection systems are typically independent of navigation systems, limiting a UAV's ability to respond in real-time to emerging threats or dynamic obstacles.

Nano drones, also known as Micro Air Vehicles (MAVs), have emerged as promising solutions due to their small size, lightweight construction, and energy-efficient design, making them ideal for navigating confined spaces such as urban areas, industrial facilities, and dense foliage. These attributes enable nano drones to perform tasks such as search and rescue, environmental monitoring, and precision agriculture. However, their limited payload capacity restricts the integration of powerful sensors and processors, posing challenges in achieving effective autonomous navigation and situational awareness.

To overcome these limitations, researchers have drawn inspiration from nature, modeling nano drone systems on the highly efficient neural architectures of insects such as fruit flies and bees. This has led to the development of artificial insect intelligence, which combines vision-based navigation, neural network-driven decision-making, and real-time obstacle avoidance. By leveraging bio-inspired algorithms and machine learning models, such as convolutional neural networks (CNNs) and recurrent neural networks (RNNs), nano drones can autonomously detect and avoid obstacles, plan optimal paths, and adapt dynamically to environmental changes—without relying on external signals like GPS. This integrated approach significantly enhances the versatility and capabilities of nano drones, expanding their potential applications to include autonomous inspection, secure surveillance, and more.

The head direction (HD) system found in fruit flies provides a biologically inspired solution for autonomous orientation and navigation. Fruit flies utilize a specialized neural network within their central complex to integrate visual, mechanosensory, and proprioceptive inputs, thereby maintaining an internal compass-like representation of their orientation. By replicating this biological mechanism through artificial neural networks, the present invention enables UAVs to navigate with high precision and reliability, even in the absence of external positioning systems like GPS.

Additionally, the inclusion of an intelligent intrusion detection module allows the UAV to identify, classify, and respond to potential threats in real-time. This module serves as a robust security layer, empowering the UAV to execute evasive maneuvers, re-plan flight routes, and communicate with other systems upon detecting potential intrusions. By integrating these capabilities, the proposed system effectively addresses key challenges in autonomous UAV operations, including secure navigation, enhanced situational awareness, and dynamic threat response, making it suitable for both terrestrial and extraterrestrial applications.

Existing UAV navigation systems, such as those disclosed in [US20170094527A1] and [US-201615279425-A], primarily depend on radio signal-based localization, which can be unreliable and prone to signal loss in GPS-denied environments. Moreover, these systems lack the capability to dynamically adjust their navigation paths in response to environmental obstacles and intrusions, rendering them inadequate for navigating complex or unstructured terrains. Similarly, traditional UAV intrusion detection methods, like those in [US20170094527A1], are limited to analyzing known signal protocols, making them ineffective in detecting unknown or complex multi-sensor threats.

In contrast, the present invention introduces a hybrid neural network model that combines Convolutional Neural Networks (CNNs) and Recurrent Neural Networks (RNNs) to perform real-time classification and anomaly detection. By leveraging multi-modal sensor inputs such as visual, radar, and LIDAR data, this system significantly improves accuracy and reliability compared to existing solutions. Additionally, unlike prior art that relies solely on predefined waypoints for navigation, the invention employs reinforcement learning models to dynamically update flight paths, allowing the UAV to autonomously adapt to changing environmental conditions, including moving obstacles or signal interference. This adaptability results in a substantial enhancement in operational flexibility, safety, and overall performance.

### SUMMARY OF THE INVENTION

The invention provides an integrated bio-inspired navigation and intrusion detection system for UAVs. The key components of the invention include:
Neural Network-Based Navigation System: A CNN-based architecture that processes visual inputs, detects optic flow, and maintains an internal orientation representation using a ring attractor network, similar to the head direction (HD) system in fruit flies. This system enables the UAV to navigate in complex, GPS-denied environments by continuously updating its heading and position based on visual and sensory cues.
UAV Intrusion Detection Module: A machine learning-based model that processes inputs from sensors such as radar, cameras, and LiDAR to detect and classify potential UAV intrusions or obstacles. The module employs techniques such as CNNs, RNNs, or anomaly detection algorithms to identify the presence of other UAVs, classify the type of intrusion, and assess the level of threat.
Sensor Fusion and Decision-Making Module: Integrates data from the navigation system and intrusion detection module to make real-time decisions. The module combines sensory data using fusion algorithms and implements decision-making strategies to prioritize navigation and security tasks.
Navigation and Control System: For UAV operations in both Earth and extraterrestrial environments, the Navigation and Control System needs to be robust, adaptive, and capable of functioning under a wide range of conditions. Depending on the environment, the UAV may leverage different tools and methods for navigation, obstacle avoidance, and autonomous control.
Navigation:
In Earth environments, UAVs can utilize GPS for accurate positioning. However, in GPS-denied environments, such as dense urban areas, forests, or subterranean locations, the UAV would switch to other methods like Inertial Measurement Units (IMUs), visual odometry, and signals from stationary beacons or nearby nodes for localization. In scenarios where GPS is unavailable, like deep caves or indoor spaces, the UAV would depend on SLAM (Simultaneous Localization and Mapping) algorithms to simultaneously build a map of its surroundings and track its own position in real time.
In addition, UAVs can use visual cues and surface landmarks obtained through onboard cameras and LIDAR sensors to navigate more precisely. LIDAR provides accurate distance measurements, enabling the UAV to maintain spatial awareness and avoid obstacles. This combination of visual data and real-time mapping ensures the UAV can navigate effectively in diverse environments, whether flying over open terrain, through cluttered environments, or within confined spaces.
Obstacle Avoidance:
To ensure safe operation, the UAV must be equipped with an Obstacle Avoidance System. Advanced sensors such as LIDAR, stereo cameras, and radar enable the UAV to detect and avoid obstacles, including buildings, trees, vehicles, and dynamic elements like other UAVs. These sensors work together to create a detailed 3D representation of the environment, allowing the UAV to identify and classify potential hazards.
A real-time obstacle avoidance system processes sensor data to make rapid decisions, adjusting the UAV's path to navigate safely around hazards. The obstacle avoidance module is particularly crucial when flying in complex or dynamic environments, such as urban areas or forested landscapes, where obstacles can appear suddenly and require immediate reaction.
Autonomous Flight Control:

Autonomous flight capabilities are essential for UAVs operating in unpredictable environments or in scenarios where communication with human operators may be delayed or disrupted. The Autonomous Flight Control System would utilize machine learning models and adaptive algorithms to respond to changing conditions, whether it's a sudden gust of wind, unexpected obstacles, or a change in mission parameters.
This system ensures that the UAV can perform maneuvers like changing heading, speed, altitude, or executing evasive actions based on real-time data from its integrated sensors. Autonomous flight is particularly useful for applications such as search and rescue, exploration, and surveillance, where the UAV needs to operate independently and make decisions without human intervention.
Navigation and Control Integration:

The Navigation and Control System integrates all these elements to create a cohesive system capable of handling diverse environments, whether on Earth or in extraterrestrial settings like Mars. The system is responsible for executing decisions made by the decision-making module, including adjusting the UAV's trajectory, altitude, and speed based on environmental data and mission requirements. By combining navigation, obstacle avoidance, and autonomous control, the UAV is able to explore, monitor, and map its surroundings efficiently and safely, adapting to both known and unknown challenges.

The present invention addresses the limitations of prior art by integrating a bio-inspired neural network-based navigation system, similar to the head direction mechanism in biological organisms, with an intelligent intrusion detection module. Unlike conventional systems that depend solely on radio signal analysis, the invention employs multi-modal sensor fusion and deep learning models, enabling autonomous UAV operation in complex environments without GPS or external guidance.

### DETAILED DESCRIPTION OF THE INVENTION

The neural network-based navigation system uses a series of convolutional and recurrent layers to process visual inputs from the UAV's camera. The visual processing system extracts features such as optic flow, object recognition, and spatial landmarks to maintain orientation and heading. The ring attractor network simulates the fly's head direction cells, creating a stable representation of the UAV's heading, which is continuously updated based on sensory inputs.

The UAV intrusion detection module employs a combination of supervised and unsupervised learning techniques to identify potential intrusions. Supervised learning methods, such as convolutional neural networks (CNNs), are used to detect and classify UAVs based on predefined classes (e.g., friendly, hostile, unknown). Unsupervised learning methods, such as clustering or anomaly detection, are used to identify unknown objects or behavior that may pose a threat to the UAV.

The sensor fusion and decision-making module integrates data from various sensors (e.g., visual, radar, LiDAR) and combines them using fusion algorithms to create a unified representation of the environment. The decision-making strategy uses a rule-based or reinforcement learning approach to dynamically update navigation paths, adjust flight parameters, or initiate evasive maneuvers when a potential threat is detected.

### Advantages of the Invention

The integrated system offers several advantages over traditional UAV navigation and security systems:
1. Bio-Inspired Navigation: By replicating the head direction system in fruit flies, the UAV can navigate autonomously in complex environments without relying on external systems such as GPS.
2. Enhanced Situational Awareness: The combination of navigation and intrusion detection enables the UAV to monitor its surroundings and respond to potential threats in real-time.
3. Robust Security Mechanism: The intrusion detection module ensures that the UAV can identify, classify, and respond to unauthorized UAVs or obstacles, enhancing airspace security.
4. Dynamic Decision-Making: The decision-making module allows the UAV to adapt to changes in the environment and perform autonomous navigation and security tasks with minimal human intervention.

### BRIEF DESCRIPTION OF THE DRAWINGS

FIG. 1 shows the interconnectedness of a few key neurons with the Central Complex (CX), which is responsible for maintaining spatial orientation and directionality in fruit flies. This layout helps visualize how a minimal set of neurons can achieve complex navigational behaviors, contradicting previous theories that large networks were necessary for such precision. The diagram highlights the following components:
Central Complex (CX): Serves as the core computational center, integrating inputs from other neurons and coordinating the fly's directional movements.
Neuron 1 (N1): Receives input from external cues, such as visual or sensory data, and relays it to the CX for processing.
Neuron 2 (N2): Interprets head direction based on internal or external directional cues, sending information to the CX.
Neuron 3 (N3): Sends directional signals to maintain the correct flight path.
Neuron 4 (N4): Maintains position data, ensuring the CX has updated information about the fly's spatial location.

FIG. 2 illustrates how a fruit fly navigates through its environment. The path demonstrates a series of behavioral adaptations that allow the fly to navigate effectively using its highly sensitive sensory organs to detect changes in its surroundings, such as air currents, visual landmarks, and scent cues. As the fly encounters an obstacle, it rapidly adjusts its trajectory, facilitated by the CX, to avoid collision and continue towards its goal (e.g., a food source). This diagram underscores the efficiency of the fly's compact neural network in maintaining spatial awareness and goal-oriented movement.

FIG. 3 draws an analogy between fruit fly navigation and UAV (Unmanned Aerial Vehicle) navigation. The left side represents a fruit fly's navigation using its Central Complex (CX) to detect food sources, avoid obstacles, and make precise maneuvers. On the right side, a UAV mirrors the fly's behavior using an advanced navigation and detection system to identify target locations and detect intrusions. The arrow in the middle highlights the Bio-Inspired Neural Navigation System concept, showing how principles from the fly's neural pathways can be adapted to UAV systems, enhancing the UAV's navigation and decision-making capabilities.

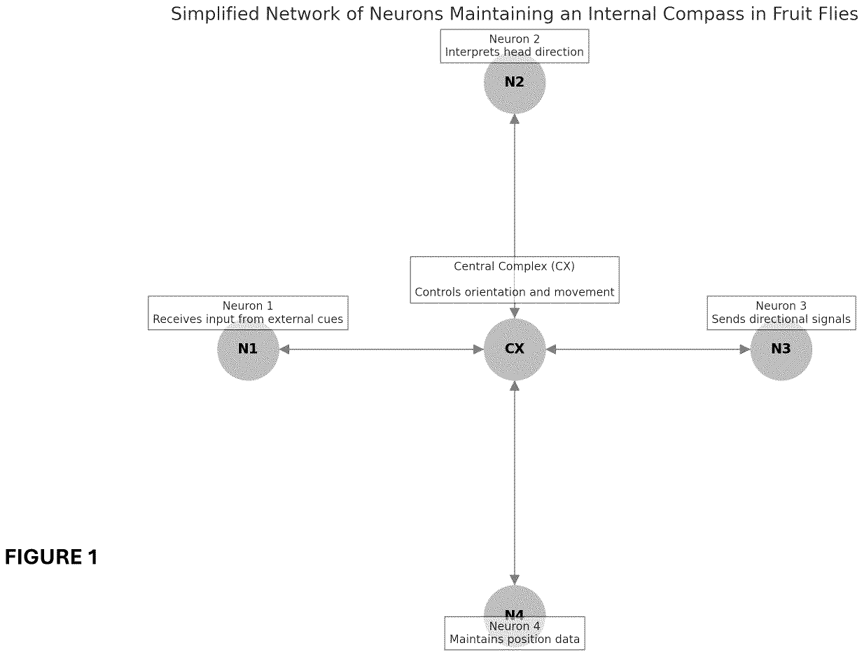

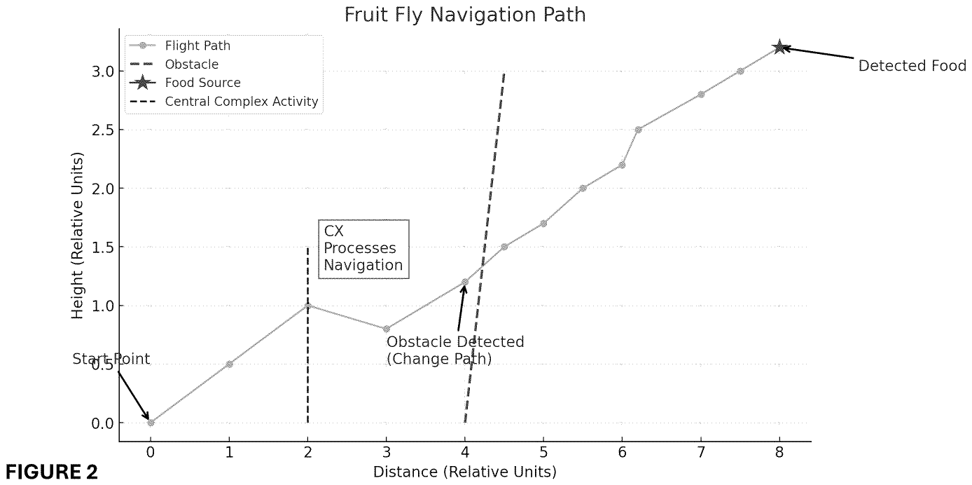

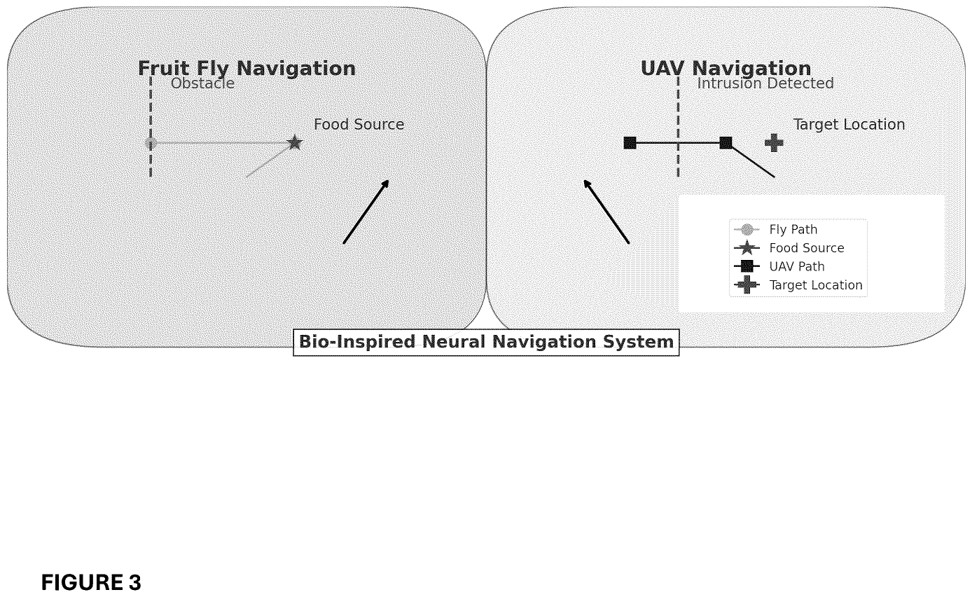

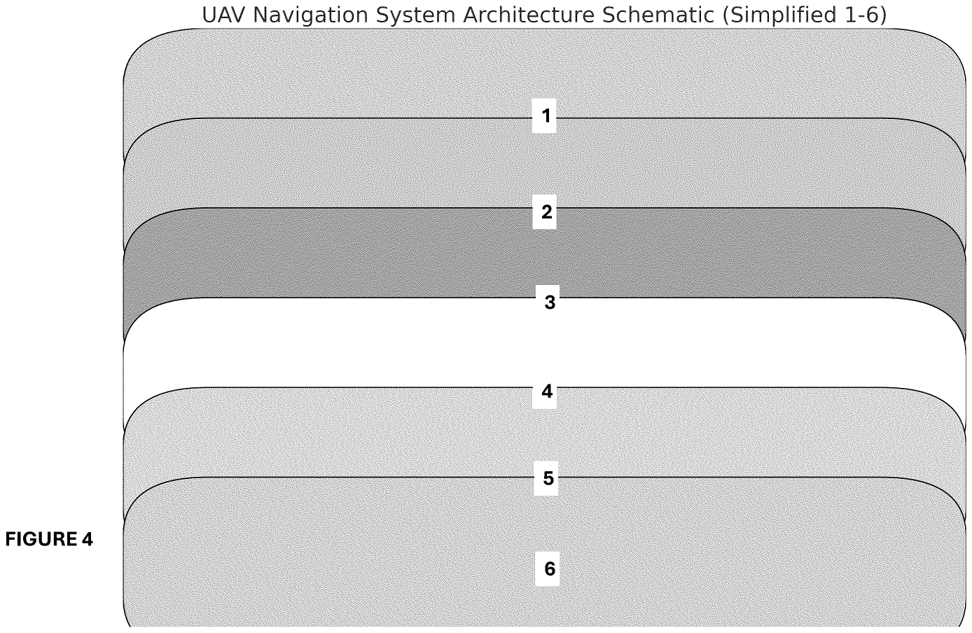

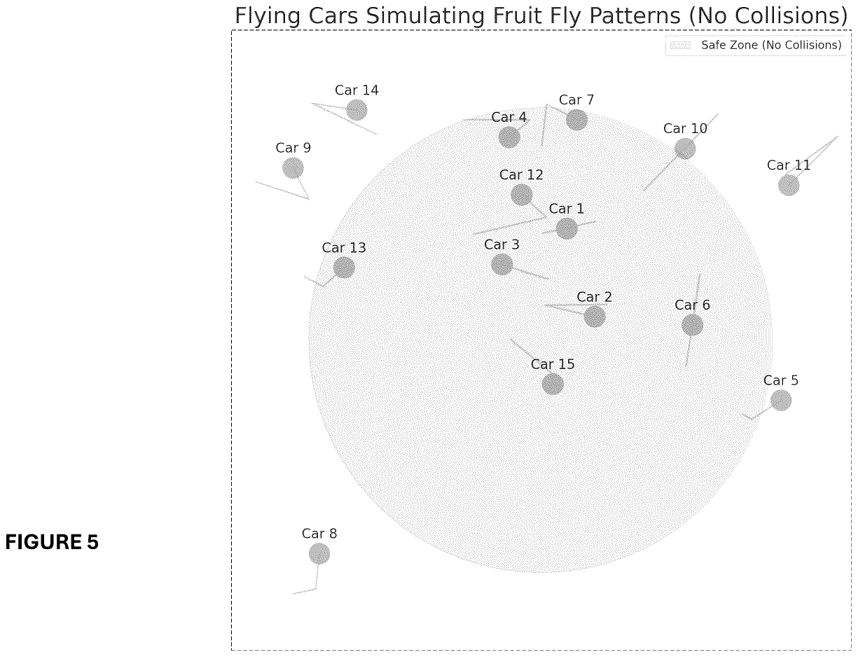

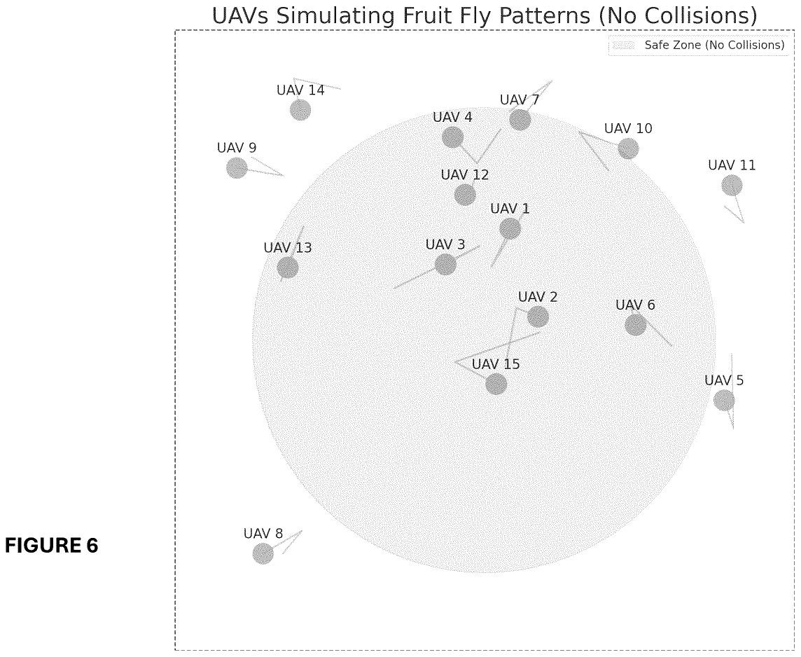

FIG. 4 shows the UAV Navigation System Architecture comprising several components:
Sensor Suite: Includes visual sensors (cameras), LiDAR/radar sensors, GPS & IMU for positioning, and optionally, olfactory sensors for chemical detection.
Pre-Processing Unit: Combines sensor data into a unified representation and filters noise to enhance relevant signals.
Bio-Inspired Navigation Core: Utilizes the Central Complex Module, Head Direction Cells, and Compass Network for spatial orientation, while Path Integration and Memory Integration modules handle positional updates and learned data storage.
Decision-Making and Control Layer: Contains modules for obstacle avoidance, target acquisition, and behavioral decision-making.
Feedback and Learning System: Employs reinforcement learning and anomaly detection to optimize navigation and respond to environmental changes.
Control and Actuation Layer: Manages the UAV's flight control, motor control, and stability for precise maneuverability.

FIG. 5 is an illustration of flying cars simulating fruit fly patterns, navigating within a shared space without colliding with each other. Each car has its own path, avoiding overlaps and maintaining a safe distance, much like fruit flies coordinating in flight. The diagram emphasizes the coordination and non-collision behavior of multiple entities in a shared space.

FIG. 6 is similar to FIG. 5 but depicts UAVs instead of flying cars. Each UAV simulates fruit fly patterns, maintaining safe distances from each other while navigating within the shared space. This analogy demonstrates how bio-inspired navigation principles can be applied to UAVs, allowing them to operate autonomously without collisions in dynamic

The integrated system is suitable for a wide range of applications, including but not limited to:
1. Autonomous Surveillance and Patrolling: UAVs equipped with this system can autonomously patrol designated areas, detect intrusions, and respond dynamically to potential threats.
2. Border Monitoring and Security: The system can be deployed to monitor border areas, detect unauthorized UAVs, and provide real-time alerts and responses.
3. Urban Air Traffic Management: The system can manage low-altitude airspace in urban areas, avoiding collisions with other UAVs and ensuring safe navigation.
4. Military and Defense Applications: The system can be used for reconnaissance missions, where UAVs need to navigate through complex environments and detect potential enemy UAVs.

Future enhancements to the system could include the integration of multi-UAV coordination for swarm intelligence, advanced anomaly detection algorithms, and adaptive learning mechanisms to improve performance in dynamic and unknown environments.

The proposed bio-inspired navigation and intrusion detection system provides a robust solution for secure, autonomous UAV navigation. By combining neural network-based navigation with real-time intrusion detection, the system ensures safe and intelligent operation in complex and GPS-denied environments.

In a practical implementation of the present invention, a nano drone equipped with the integrated bio-inspired navigation and intrusion detection system is deployed to autonomously navigate through a complex indoor environment, such as a multi-story industrial facility with narrow passages and high-density obstructions.

Scenario:

The nano drone is tasked with conducting an autonomous inspection and security patrol within the facility, which consists of multiple floors, machinery, and infrastructure elements that create a GPS-denied environment. Upon launch, the drone initializes its Neural Network-Based Navigation System to establish its internal orientation using a simulated head direction (HD) system, similar to the orientation mechanism found in fruit flies. The system utilizes onboard visual sensors and inertial measurement units (IMUs) to track optic flow and spatial landmarks, generating a real-time map of its surroundings.

As the nano drone begins its patrol, it uses its UAV Intrusion Detection Module to actively monitor the environment for potential intrusions or hazards. The module employs a combination of Convolutional Neural Networks (CNNs) and Recurrent Neural Networks (RNNs) to analyze data from integrated radar, LiDAR, and visual sensors. During its patrol, the drone detects an unknown flying object within its vicinity. Leveraging its intrusion detection capabilities, the drone classifies the object as a potential unauthorized UAV based on its flight pattern, size, and radar signature.

Adaptive Navigation and Security Response:

In response to the detected intrusion, the drone dynamically adjusts its flight path using its Sensor Fusion and Decision-Making Module. This module integrates data from the navigation and intrusion detection systems to evaluate possible responses. The drone initiates an evasive maneuver, re-routing its path to avoid a potential collision while maintaining line-of-sight with the object to continue monitoring its behavior. Additionally, the drone broadcasts a security alert to the facility's control center, including details of the detected UAV, its classification, and its estimated flight trajectory.

The drone's Navigation and Control System further adapts to the environmental changes, ensuring stable and continuous navigation despite the presence of moving obstacles and signal interference caused by dense metallic structures within the facility. Utilizing its reinforcement learning model, the system autonomously learns from these environmental interactions and refines its future navigation strategies for improved performance.

Real-Time Decision-Making and Reporting:

As the detected UAV approaches a restricted area within the facility, the nano drone's intrusion detection system classifies the object as a high-risk intrusion based on its proximity and trajectory. The drone activates its high-priority response protocol, using its onboard communication system to transmit a real-time video feed and detailed environmental data back to the control center for further analysis and potential human intervention. The drone then follows the unauthorized UAV, maintaining a safe distance while continuously updating its flight path using the dynamic navigation system.

This example demonstrates how the integrated bio-inspired navigation and intelligent intrusion detection system of the present invention enables a nano drone to autonomously navigate, detect, classify, and respond to dynamic environmental changes and potential security threats in real time, making it highly effective for use in complex, GPS-denied environments such as industrial facilities, urban landscapes, or extraterrestrial settings.

### EXAMPLE

In this example, we are using the SkyCity: The City Landscape Dataset as our basis. The SkyCity dataset contains aerial images of various urban landscapes and can be used to simulate the drone's navigation through complex city environments. It is suitable for object detection and navigation tasks. For this example, we will load the SkyCity dataset, preprocess the images, and implement a simplified version of the fruit fly-inspired navigation algorithm that uses visual input for navigation.

### Define and Compile the Central Complex (CX) Module:

The build_cx_module_model function constructs a Keras Sequential model, using a CNN-based architecture to simulate the Central Complex module in fruit flies.

### Training and Saving the Model:

The model is trained using dummy data (dummy_images and dummy_labels). In a real-world application, replace this with actual image data and labels from a dataset like SkyCity or EuRoC MAV.
The trained model is saved to an. hc5 file (cx_module_model.h5) using model.save( ).

### Loading the Saved Model:

The saved model is reloaded using tf.keras.models.load_model( ), allowing the navigation system to use it for inference without retraining.

### Simulated Navigation Path:

The simulate_navigation_with_loaded_model function simulates a navigation path using the loaded CX module model. It updates Head Direction (HD) cell states based on the predicted direction from the model.

### Visualization of Navigation Path:

The navigation path is plotted, showing the sequence of directions chosen by the simulated UAV as it navigates using the fruit fly-inspired navigation model.
   For the example code, we are using the following default values:
Current Orientation: Stable position with no rotation, facing North.
HD Cell States: Initial high activation in the North direction.
IMU Data: No movement or rotation.
Position and Velocity: Stationary drone at a starting altitude of 10 meters.
Detected Objects: Simulated building and car objects.
Obstacle Map and No-Fly Zones: Example rectangular areas for constraints.
Navigation State: Initial “hovering” state.
Goal Location: Target at (100, 200 meters).
Trajectory Data: Simple set of waypoints for navigation.

### Example Code for the Central Complex (CX) Module and Navigation Simulation

This example demonstrates how to build, train, save, and load a Keras-based Central Complex (CX) module. The CX module processes visual information for the fruit fly-inspired UAV navigation system. The code uses a default set of values for object detection and navigation inputs, and includes a navigation simulation using the trained model.
#Step 1: Import necessary libraries
import numpy as np
import matplotlib.pyplot as plt
import tensorflow as tf
from tensorflow.keras import layers, models
import os
#Step 2: Define the Central Complex (CX) module using a Keras-based Convolutional Neural Network (CNN)
def build_cx_module_model(input_shape=(128, 128, 3), output_size=8):

Constructs a CNN model for the Central Complex (CX) module.

Parameters:
input_shape: Shape of the input image data. Default is (128, 128, 3) for 128×128 RGB images.
output_size: Number of output neurons representing HD cell states. Default is 8.

Returns:
model: Compiled Keras Sequential model for CX module.

model=models.Sequential([
layers.Input(shape=input_shape), #Input layer for visual data
layers.Conv2D(32, (3, 3), activation=‘relu’, padding=‘same’),
layers.MaxPooling2D((2, 2)),
layers.Conv2D(64, (3, 3), activation=‘relu’, padding=‘same’),
layers.MaxPooling2D((2, 2)),
layers.Conv2D(128, (3, 3), activation=‘relu’, padding=‘same’),
layers.MaxPooling2D((2, 2)),
layers.Flatten( ),
layers.Dense(256, activation=‘relu’), #Fully connected layer
layers.Dense(output_size, activation=‘softmax’) #Output layer with 8 directional signals (HD cells)

])

return model

#Step 3: Build and compile the CX module model
cx_model=build_cx_module_model( )
cx_model.compile(optimizer=‘adam’, loss=‘categorical_crossentropy’, metrics=[‘accuracy’])
#Step 4: Generate dummy training data for model demonstration purposes
#Replace this dummy data with actual image data and labels in a real implementation
dummy_images=np. random. rand(100, 128, 128, 3) #Generate 100 dummy images of size 128×128 RGB
dummy_labels =np. zeros((100, 8)) #Generate 100 dummy labels for 8 directional outputs
#Assign random labels to dummy data (simulating 8 directions)
for i in range(100):

dummy_labels[i, np.random.randint(0, 8)]=1

#Step 5: Train the CX module model using dummy data
cx_model.fit(dummy_images, dummy_labels, epochs=5, batch_size=16, validation_split=0.2)
#Step 6: Save the trained model for future use
model_file_path=“cx_module_model.h5”
cx_model.save(model_file_path)
print(f“Model saved to {model_file_path}”)
#Step 7: Load the saved model to integrate into the navigation system
loaded_cx_model=tf.keras.models.load_model(model_file_path)
print(“Model loaded successfully!”)
#Step 8: Test the loaded model with new dummy data for inference
test_image=np.random.rand(1, 128, 128, 3) #Create a random image for testing the model
prediction=loaded_cx_model.predict(test_image) #Perform a prediction
predicted_direction=np.argmax(prediction) #Get the direction with the highest activation
#Display the predicted direction
print(f“Predicted direction (HD cell index) from loaded model: {predicted_direction}”)
#Step 9: Implement the navigation simulation using the loaded model
def simulate_navigation_with_loaded_model(loaded_model, num_steps=20):

Simulates navigation using the trained CX module model for a specified number of steps.

Parameters:
loaded_model: Trained Keras model for the CX module.
num_steps: Number of navigation steps to simulate. Default is 20.

Returns:
navigation_path: List of directions (HD cell indices) traversed by the simulated UAV.
#Initialize Head Direction (HD) cell states to represent initial orientation
hd_cell_states=np.zeros(8)
hd_cell_states[0]=1.0 #High activation in the “North” direction

#Initialize a list to track the navigation path

navigation_path=[]

#Simulate navigation for the given number of steps

for step in range(num_steps):
#Generate a random image input for testing (replace with real images for actual use)
image_input=np.random.rand(1, 128, 128, 3)
#Perform inference using the loaded CX model
visual_output=loaded_model.predict(image_input)
direction=np.argmax(visual_output) #Get the predicted direction
#Update HD cell states based on the chosen direction
hd_cell_states=np.roll(hd_cell_states, direction)
hd_cell_states=hd_cell_states*0.8 #Decay current HD cell states
hd_cell_states[direction]+=0.2 #Increase activation in the chosen direction
#Append the current direction to the navigation path
navigation_path.append(direction)
#Print the current step and orientation
print(f“Step {step +1}: Current Orientation−{direction}”)

return navigation_path

#Step 10: Execute the navigation simulation using the loaded model
navigation_path_simulated=simulate_navigation_with_loaded_model(loaded_cx_model, num_steps=20)
#Step 11: Visualize the simulated navigation path based on HD cell orientations
plt.figure(figsize=(10, 5))
plt.plot(navigation_path_simulated, marker=‘o’)
plt.xlabel(‘Simulation Steps’)
plt.ylabel(‘Direction (HD Cell Index)’)
plt.title(‘Simulated Navigation Path using Fruit Fly-Inspired Navigation Model’)
plt.show( )

1. A bio-inspired navigation system for Unmanned Aerial Vehicles (UAVs) and nano drones, comprising:
A vision-based navigation module utilizing convolutional neural networks (CNNs) to process real-time visual inputs, detect optic flow, and maintain an internal orientation representation;
An artificial ring attractor network configured to replicate the head direction system found in biological organisms, wherein said ring attractor network continuously updates the UAV's heading direction based on environmental landmarks, optic flow patterns, and other sensory inputs;
A sensor fusion module that integrates data from visual, gyroscopic, and environmental sensors to provide real-time updates to the navigation module, allowing stable flight and autonomous navigation in complex, GPS-denied, or confined environments.

2. The system of claim 1 further comprising an intelligent intrusion detection module, wherein:
The intrusion detection module utilizes machine learning algorithms, including both supervised and unsupervised learning models, to detect, classify, and predict the behavior of intruding UAVs, obstacles, or objects using inputs from a combination of radar, visual, LiDAR, and acoustic sensors;
The module employs a multi-stage detection process, comprising signal processing, visual identification, motion analysis, and object classification, to determine the threat level of an intruding UAV or object and transmit threat assessment data to the decision-making module for real-time response.

3. A method for integrating bio-neural navigation with intelligent intrusion detection for UAV and nano drone systems, comprising:
Receiving real-time visual inputs and extracting navigational features using a CNN-based feature extraction network to recognize visual cues, detect objects, and analyze optic flow patterns;
Updating an internal orientation representation using a bio-inspired ring attractor network that maintains stable navigation based on visual and sensory cues from the environment;
Detecting potential intrusions by analyzing multi-sensor data through a hybrid neural network combining CNNs and Recurrent Neural Networks (RNNs) for temporal analysis and threat prediction;
Performing real-time fusion of navigation and intrusion detection data to dynamically adjust the UAV's trajectory and initiate evasive maneuvers in response to detected threats or obstacles in diverse environments, including GPS-denied regions or indoor spaces.

4. The method of claim 3, wherein the UAV's navigation path is dynamically re-planned using reinforcement learning-based algorithms that optimize flight paths based on real-time environmental conditions and detected threats, enabling autonomous evasion of intruding UAVs or obstacles, and ensuring safe flight in complex or cluttered environments.

5. A UAV navigation and security system for nano drones, comprising:
A bio-inspired orientation maintenance module that replicates the head direction neural network in biological organisms for continuous heading representation and orientation stability;
An intelligent threat recognition and classification module configured to analyze multiple types of sensor data, including visual, acoustic, and electromagnetic signals, for detecting UAV intrusions and classifying them as friendly, hostile, or unknown;
A decision support module that leverages machine learning models to assess the behavior of detected intrusions and determine appropriate responses, including evasive maneuvers, communication with ground control, or active countermeasures.

6. The system of claim 5, wherein the intelligent threat recognition and classification module uses unsupervised clustering algorithms to identify unknown intrusions by grouping detected objects based on feature similarity, allowing for the discovery of new or previously unclassified UAV or nano drone threats.

7. A UAV navigation system for autonomous operation in complex environments, comprising:
A neural network-based visual processing unit that detects optic flow and extracts high-level navigational features from real-time camera inputs to identify objects and obstacles;
An artificial head direction network that maintains an internal representation of the UAV's orientation relative to visual landmarks, enabling stable navigation in GPS-denied environments;
A multi-modal intrusion detection system that integrates data from radar, LiDAR, and acoustic sensors, providing a comprehensive threat assessment based on environmental inputs;
An adaptive response system that employs a deep reinforcement learning model to update navigation paths and execute evasion strategies based on detected intrusions or obstacles.

8. The system of claim 7, wherein the visual processing unit is configured to detect changes in optic flow patterns indicative of nearby intruding UAVs, and the intrusion detection system generates a probabilistic threat score based on the UAV's proximity, velocity, flight pattern, and movement characteristics.

9. A method for bio-neural navigation and intelligent intrusion detection in nano drones, comprising:
Training a CNN-based navigation model on biological optic flow datasets to replicate insect-inspired navigation mechanisms and visual processing;
Implementing a ring attractor network for orientation stability, which updates its state based on visual and gyroscopic sensor inputs to maintain heading direction and positional awareness;
Training a hybrid neural network model for intrusion detection using labeled datasets of known UAV or nano drone intrusions and anomalies, and employing clustering techniques to identify new or unknown threats;
Integrating real-time intrusion detection outputs with the navigation module to autonomously adjust the UAV's flight parameters, enabling real-time collision avoidance and threat evasion in dynamic environments.

10. The method of claim 9, wherein the ring attractor network is configured to adapt its internal state using reinforcement learning based on sensory feedback, ensuring stable navigation and threat evasion even in the presence of strong external perturbations or GPS signal loss, providing robust navigation in both terrestrial and extraterrestrial applications.
